(19) United States
(12) Patent Application Publication
(10) Pub. No.: US 2018/0365607 A1
(43) Pub. Date: Dec. 20, 2018

(54) SYSTEMS, APPARATUS, AND METHODS FOR DETERMINING ACTIVITIES OF RESOURCES

(71) Applicant: MetroStar Systems, Inc., Reston, VA (US)

(72) Inventors: Ali Reza Manouchehri, Reston, VA (US); Jorge Luis VASQUEZ, Fairfax, VA (US)

(73) Assignee: MetroStar Systems, Inc., Reston, VA (US)

(21) Appl. No.: 15/624,919

(22) Filed: Jun. 16, 2017

(51) Int. Cl. G06Q 10/06; G06F 11/34; G06F 11/30; G06F 11/32

(52) U.S. Cl. CPC G06Q 10/0631; G06F 11/328; G06F 11/302; G06F 11/3466

(57) ABSTRACT

Embodiments described herein are directed systems and methods that include the actions of receiving sensor data from a sensor configured to monitor a resource and analyzing the sensor data to identify one or more determined activities of the resource. A determined activity is selected, based on criteria, for a collection of additional information, and a query is generated for the collection of the additional information to reduce an error potential of the determined activity. The query is transmitted and results are received. Based on the results, the determined activity is updated, then stored with a timestamp as an activity data object in an activity data store. A record is generated that comprises the determined activity.

### TECHNICAL FIELD

This specification relates generally to systems, apparatus, and methods for monitoring resources in an enterprise, and more particularly to systems, apparatus, and methods for determining activities of resources using sensor data and queries.

### BACKGROUND

Traditionally, businesses have tracked the activities and expenses of resources used for different tasks. The activities tracked, for example for human resources, include time spent directly working on tasks, travel time, expenses, break time, and other uses of time. Time and expense tracking can lead to benefits in areas including billing, payroll, expense tracking, and planning. Approaches to tracking time and expenses however, have generally relied upon human activity to do the tracking, e.g., filling in timesheets and expense sheets to capture data.

The processes for tracking time and expenses spent on activities by resources have evolved over time. Even applying computer technology, the processes still involve having a resource take responsibility for keeping track of their own use of time using different tools. Paper punchcards and paper timesheets have evolved to be computerized “timesheets” created with the entry of time values into a user interface. Even new approaches still only offer different ways for a person to report the time spent on different activities.

Self-reporting approaches to time and expense tracking have been subject to different types of problems. While reporting systems are set up to allow time reporting at least once a day (ideally, as the time is spent), very often time is entered into a system at longer intervals than a day. Late time entry can cause problems for an enterprise beyond just not having the time available for processing.

Entering time at any time other than when a task is completed can lead to inaccuracies in time entry. Entering expenses at any time other that when an expense is incurred can cause similar problems. The longer the interval, the higher the likelihood of errors in projects worked on, activities completed, and the actual time spent. Lack of records can lead to guessing of all of three of these types of values, or even worse, no time entered at all for work completed.

Because of the different business activities that use time tracking values, inaccurate time and expense entry predictably leads to many different problems in the modern enterprise. Inaccurate data can lead to short term problems, like erroneous customer billing and missing expense reimbursement. Because time tracking is used for planning future projects as well, inaccurate tracked data can lead to far more significant problems.

Efforts made to improve the accuracy and comprehensiveness of tracked time and expenses tend to involve creating easier ways for workers to voluntarily enter time values into a time tracking system. Because these approaches rely upon workers entering their own time, at their own intervals, based on their own potentially vague recollection of time spent on myriad activities, these approaches generally have the same problems as traditional systems, i.e., time and expenses entered irregularly, inaccurate data, improper use of task codes, confusion of billable and unbillable time, and missing data.

### SUMMARY

In general, one innovative aspect of the subject matter described in this specification may be embodied in methods that include the actions of receiving sensor data from a sensor configured to monitor a resource and analyzing the sensor data to identify one or more determined activities of the resource. A determined activity is selected, based on criteria, for a collection of additional information, and a query is generated for the collection of the additional information to reduce an error potential of the determined activity. The query is transmitted and results are received. Based on the results, the determined activity is updated, then stored with a timestamp as an activity data object in an activity data store. A record is generated that comprises the determined activity. To enable additional uses, in some embodiments, received results are automatically categorized.

Other embodiments of these aspects include corresponding systems, apparatus, and computer-readable medium storing software comprising instructions executable by one or more computers, which cause the computers to perform the actions of the methods.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 illustrates components of a system for determining activities of resources, according to some embodiments.

FIG. 2-3 are examples of user interfaces used by some embodiments to enable responding to a query from an activity determining component, according to some embodiments.

FIG. 4 illustrates an interaction between an agent and a device used by some embodiments to determine activities of resources.

FIG. 5 illustrates a detailed view of an activity determining component in a system for determining allocations of resources.

FIG. 6-7 illustrate a query queue and a results queue, used as a complex data structures by some embodiments.

FIG. 8 is a flowchart of different approaches to generating time records for resources using determined activities, according to some embodiments.

FIG. 9 is a flowchart of a method of determining activities of resources, according to some embodiments.

FIG. 10 is a diagram of an exemplary hardware, software, and communications environment used to implement some embodiments.

FIG. 11 is a diagram of an example mobile electronic device used to implement some embodiments.

### DETAILED DESCRIPTION

For some embodiments described herein, activities of resources are determined by collecting data from different sources, including sensor data (e.g., sensors accessed through an enterprise security system or stand-along sensors), data from enterprise applications used by the resource (e.g., scheduling systems, email, intranets, internal collaboration systems, source control systems), external data systems (e.g., geographic systems, weather information systems, external collaboration systems), and by queries to the resource.

It should be noted that, as used herein, activities of a resource also includes expenses incurred by a resource. One having skill in the relevant art(s), given the description herein, will appreciate how approaches described herein apply to both time and expenses.

In an example of sensors used by some embodiments, sensors can be configured to monitor certain spaces associated with resources, e.g., storage spaces, workstations, offices, entrances and exits, etc. In another example, furniture associated with resources (e.g., chairs, tables) can be monitored to provide useful information to some embodiments about the activities of resources.

Another type of system, external to an organization, that can be accessed by some embodiments, is an alert system (e.g., global, national, and regional alert systems), along with emergency broadcast systems, and other public safety notification systems, e.g., woozy recall and safety alert systems. Having access to these types of systems can provide useful data to embodiments about the availability of resources at different times, e.g., during a tornado watch or a blizzard, estimates of the activities of a resource may be affected.

Additional sources of data, and different approaches to combining data collected to determine activities, are discussed further herein. In addition, uses to which determined activities may be applied by some embodiments are discussed, e.g., determining a proposed timesheet describing activities and times allocated, for a resource.

As used to describe some embodiments, a resource can be any entity capable of engaging in different activities in an enterprise, e.g., a combination of one or more of mechanical, electronic, or human resources. Resources described herein can also provide information in response to queries, e.g., information about a task or activity performed by the resource.

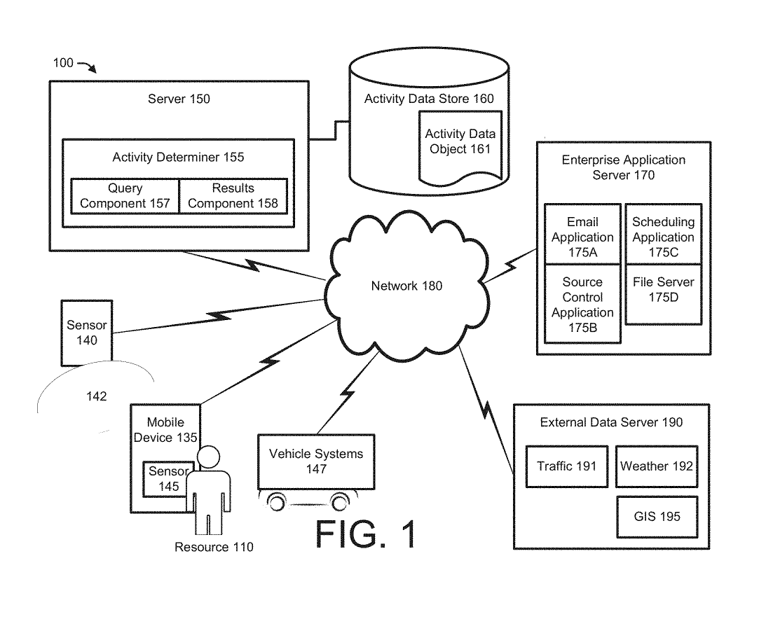

FIG. 1 depicts a system 100 for determining activities of resources in accordance with some embodiments. System 100 includes server 150 coupled to activity data store 160 and network 180. Activity data store 160 is depicted as storing activity data object 161. As depicted, server 150 is a computer server hosting activity determiner 155, which is configured to determine activities of resource 110, using data collected from different data sources, including one or more of mobile device 135 (both from sensor 145 and mobile applications), sensor 140, and vehicle systems 147, each source being coupled to network 180. In another example of sensors that can be configured to monitor resources, sensors can be placed within living organisms (i.e., implants) to provide data that can be useful to determining activities of resources.

To determine activities of resources, embodiments of activity determiner 155 may also collect and analyze data from enterprise application server 170 and external data server 190. As described herein, enterprise application server 170 represents one or more servers hosting one or more enterprise applications, including email application 175A, source control application 175B, scheduling application 175C, file server 175D, or other similar applications, e.g., applications that collect enterprise data using stand-alone sensors. External data server 190 represents one or more computer servers hosting data external to an enterprise, e.g., traffic 191 data, weather 192 data, geographic information systems (GIS) 195 data, or other similar data sources, e.g., different external systems discussed above. As discussed further below, some embodiments of activity determiner 155 may determine activities of a resource by receiving sensor data from sensors monitoring resource 110, and combining that data with data retrieved from other data sources, such as enterprise server application 170 and external data server 190.

Examples of types of information from enterprise application server 170 include: source control systems (e.g., check-in and check-out of documents by a resource), activity information suggesting the occurrence of different non-work activities in a day (e.g. morning arrival, lunch, afternoon break, etc.), and conversations conducted with other resources throughout the day (e.g., captured using collaboration systems). Other events that can be monitored by accessing enterprise application server 170 include meetings, phone calls, and tasks completed.

Network 180 may be any network or combination of networks that can carry data communications. Such a network 180 may include, but is not limited to, a local area network, metropolitan area network, and/or wide area network such as the Internet. Network 180 can support protocols and technology including, but not limited to, World Wide Web (or simply the “Web”), protocols such as a Hypertext Transfer Protocol (“HTTP”) and HTTPS protocols, and/or services. Intermediate web servers, gateways, or other servers may be provided between components of the system shown in FIG. 1, depending upon a particular application or environment. As shown in FIG. 1, network 180 provides communication links between server 150, enterprise application server 170, external data server 190, sensor 140, vehicle systems 147, and mobile device 135.

### Determining Activities Using Sensors

In some embodiments, sensor information may be collected by different types of sensors, both statically placed sensors and dynamically moving sensors. Statically placed sensors may include any sensor accessible to server 150 that is statically located to collect information about resource 110. Examples include: a building radio frequency identification (RFID) card readers, security badge readers, motion sensors, beacons, cameras, and other structural, and security sensors. In FIG. 1, sensor 140 is depicted with detection capabilities 142 (e.g., RFID, beacon detecting, camera, motion sensing) oriented toward resource 110. Sensor 142 detection capabilities can also represent other detection capabilities used by some embodiments, e.g., living organism sensor implants can detect organism movement and activities.

Dynamically placed sensors include sensors that are configured to move with a resource while collecting sensor information. In some embodiments, one or more of a fitness tracker, a smart watch, or a mobile phone 135 are all wearable or carryable devices that have sensors that can provide useful activity information to embodiments. Each of these devices can be configured to collect and relay sensor information, such as movement information, geographical location information, posture information (i.e., is a person sitting or standing), transportation information (i.e., is a person walking, running, riding in a car, riding in a car, plane, or boat, etc.), audio information (i.e., what types of background noise is around the resource, is there talking, is there jet/car/bus noise, what is being said around the resource), light information (e.g., is outdoor light sensed by the device), or information that may indicate the operational state of the resource (e.g., movement of a particular type suggests agitation or relaxation). To improve the operation of mobile sensor devices, some embodiments use sensors that support low bound of power operation and bandwidth, i.e., supporting body area network (BAN) and personal area network (PAN) connections.

In an example, a Bluetooth beacon may be used as a dynamic sensor that, when carried by a resource, can track the position of a resource at a location, thus providing activity information for the resource. As noted above, in some embodiments, implantable sensors can also provide information about movement within an office, and also capture and provide other types of data, such as speech generated by and near to, a resource.

Some sensors can provide data that links multiple resources together. For example, tracking the location of multiple resources 110 with global positioning system (GPS) and other position monitoring sensors discussed herein, can improve enterprise efficiency by enabling some embodiments to determine the activities of, and interactions between, multiple resources 110 at the same time.

In another example of sensors used by embodiments, resource 110 may operate, or be a passenger in, a smart car having vehicle systems 147 monitored by activity determiner 155. As used herein, vehicle systems 147 broadly include computer systems operating in a vehicle, including navigation systems, engine operation systems, safety systems, communication systems, and entertainment systems. Integrating and ingesting data points from data systems in a vehicle can enable embodiments to track travel time and mileage associated with activities as well as geographic movement data and activities performed in the vehicle. This collected vehicle data can also be used to compare the benefits of workforce locations, compare time spent in vehicle with telecommuting options, compare resource productivity, and generate resource CO₂ emission metrics.

By analyzing and storing activity information, some embodiments can also generate a separate source of data for a resource that describes other activities of the resource beyond what is stored in a task management system or scheduling system, e.g., regular arrival time at work or a client location, regular break or lunch times. One having skill in the relevant art(s), given the description herein, would appreciate additional useful information that can be detected and stored by embodiments, as well as the usefulness of this information to the prediction of a past, current, or future determining of activities. For example, if a resource is determined to engage in a particular activity at a particular time of day for multiple days, this information can be used, along with other data (e.g., sensor data, application data, etc.) to determine current activities for the resource.

One having skill in the relevant art(s), given the description herein will appreciate that similar static and dynamic sensor devices, data systems and sensor data may be used by some embodiments for determining the activities of resources. As discussed further herein,

### Querying Resources to Determine Activities

In some embodiments, the collected sensor data described above is centrally received and analyzed by activity determiner 155. Collecting and analyzing the data described above may be used to determine activities of resources without further processing. Alternatively, activities may be determined based one or more of sensor data, queries submitted to the resource, or activities submitted by a resource, e.g. in a time tracking server.

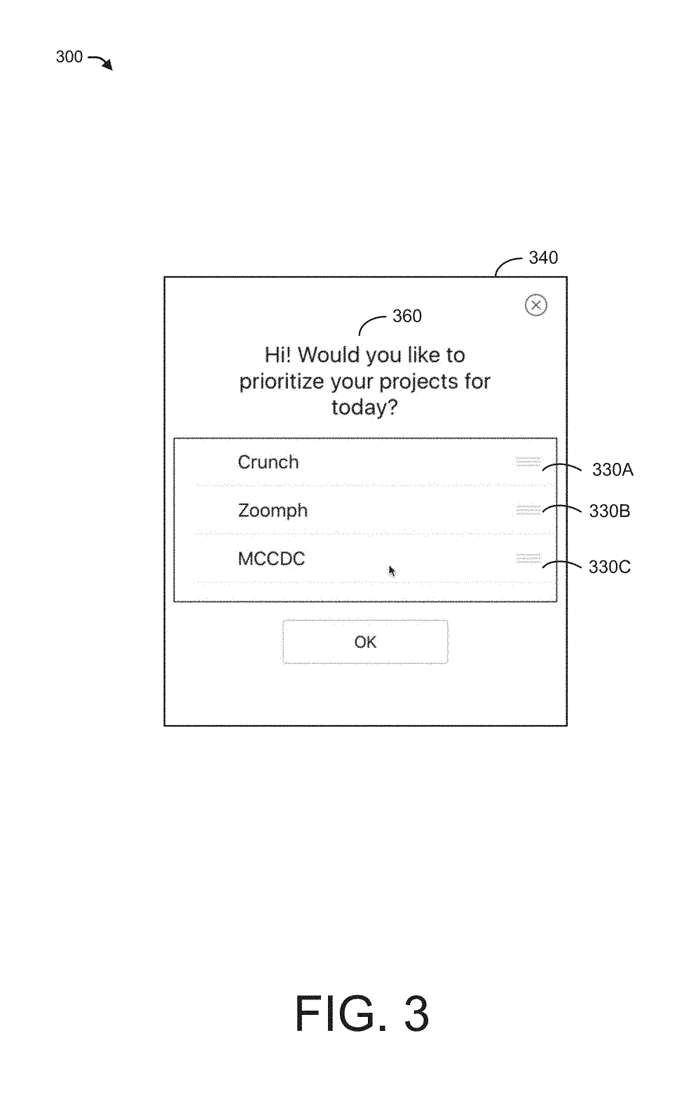

In some embodiments of activity determiner 155, activities are determined and modified throughout the day, and the final list is presented to the resource for confirmation of determined values, before a timesheet is generated. In some embodiments however, instead of generating queries for the resource at the end of the day, activity determiner 155 uses the determined activities to generate queries configured to gather extra information from resources. The query messages generated by activity determiner 155 can be directed to gathering additional information for different purposes, including confirming determined activities as they are determined (e.g., not at the end of the day), queries to determine activities for times where activity determiner 155 could not determine an activity, and queries to request information about future activities (e.g., see discussion of prioritizing activities with FIG. 3 below).

To improve the accuracy of activity determination, some embodiments receive sensor data, determine activities, then select a subset of received sensor data for further inquiry. This inquiry may include querying the resource for additional information about activities, this information being received and added to the data used to determine activities for the resource.

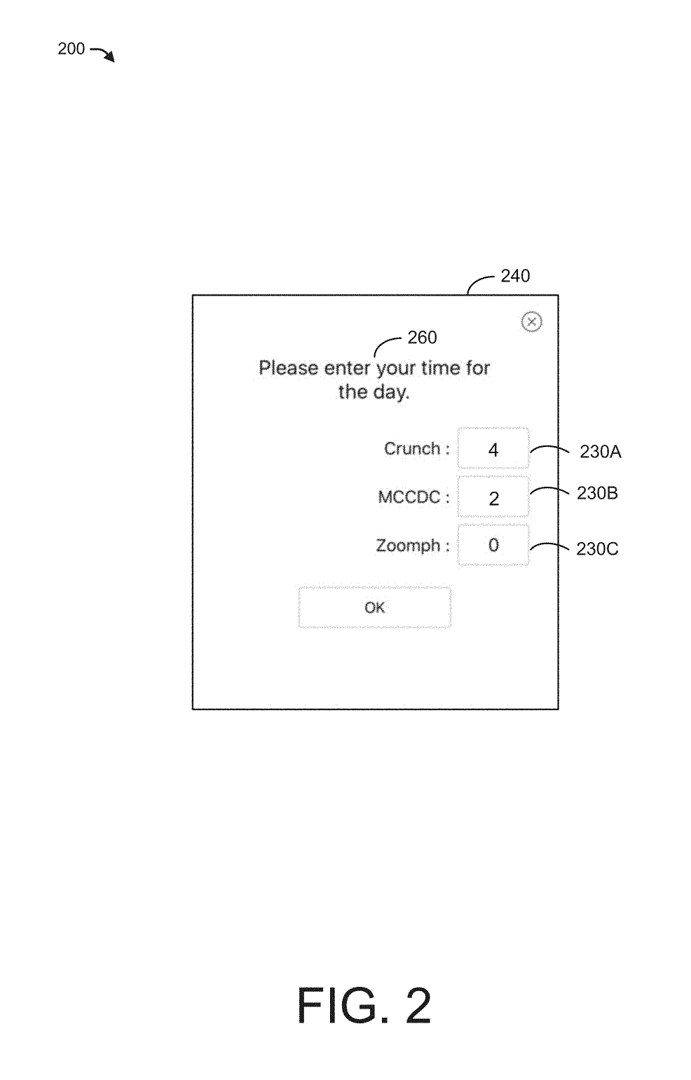

For example, when GPS and movement sensor data indicate that a resource is at a client site, and data from scheduling application 175C indicates that the resource may be engaging in several different activities at the determined location, activity determiner 155 may generate a query designed to resolve uncertainty about the current activity of the resource. In some embodiments, this query is delivered to resource 110 (e.g., using mobile device 135 or other message delivery platform), and information is provided by resource 110 in response to the query, see, e.g., the discussion of FIGS. 2 and 3 below.

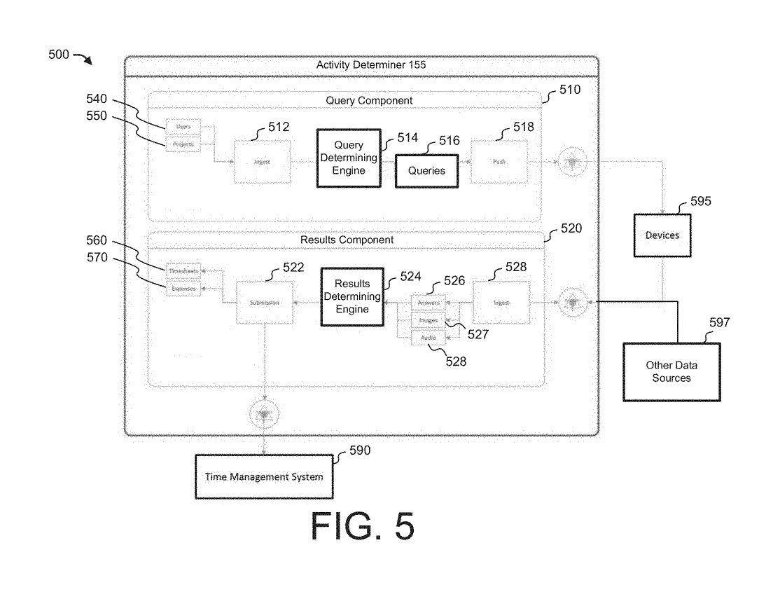

Activity determiner 155 is shown in FIG. 1 as having query component 157 and results component 158. In some embodiments, query component 157 generates the queries as described above, and results component 158 analyzes the results and integrates them into the other data used to determine activities. In some embodiments, one or more queries may be generated, the results of which are added to, and incrementally change, determined activities for a resource. Examples of implementations and uses of query component 157 and results component 158 are discussed below with the description of FIG. 5.

### EXAMPLES

Examples are discussed below that describe how some embodiments use system 100 to determine activities of resource 110. In an example, for a particular resource, in preparation for activity tracking, activity determiner 155 may retrieves information about the resource specifically (e.g., a schedule from scheduling application 175C in enterprise application server 170) and about the period of time to be tracked generally (e.g., the weather conditions from weather 191 systems for the day in external data server 190). This data can be retrieved and used by activity determiner 155 as needed, or at other intervals, i.e., even before sensors indicate that the resource is active (e.g., motion sensors 145 in mobile device 135).

Based on retrieved schedule data, scheduled events can be identified, and scheduled interactions with other resources can be identified (e.g., data from one resource can assist with tracking other resources). External data server 190 can provide data about a day that can help track activities of the resource (e.g., traffic 191 and weather 192 information can assist predictions of when a resource will be at a client site, and GIS 195 can show where a resource is located throughout the day).

In this example, the resource is scheduled to perform a task Y from 7 AM-8 AM with a first client at location X. Using scheduling application 175C, traffic 191 information, and GIS 195, activity determiner 155 determines that this scheduled activity has started. In this example, based on the data collected by sensors, activity determiner 155 determines the activity tracked and time to be “7 AM-8 AM performed task Y at location X.”

As discussed below, in some embodiments, once initially determined, this tracked activity may be modified or deleted based on data collected. For example, sensor 145 in mobile device 135 can provide additional data to enable activity determiner 155 to more accurately determine the starting times and ending times of different activities of the resource. Sensor 145 represents one or more of the sensors of mobile device 145, e.g., global positioning service (GPS), accelerometer, microphone, camera, light sensor, etc. (the components of mobile device 145 are described in more detail with FIG. 12 below). In this example, activity determiner 155 receives data from the GPS sensor in mobile device 145 that indicates that the resource arrived early to location X. In some embodiments, this information can be used to alter the determined activity noted above.

For example, once at the location X, based on data received from the accelerometer of mobile device 145, activity determiner 155 may establish that the resource has less movement starting at 6:55 AM. Based on this information, the previous tracked activity start time of 7 AM can be modified to be starting at 6:55 AM. Similarly, if GPS and accelerometer data indicate that, after the activity began at 6:55 AM, the resource did not have significant movement until 7:45 AM. Based on this additional information, the ending time for the determined activity can be modified to be 7:45 AM (e.g., the time the movement level of resource 110 changed) from scheduled 8 AM ending time.

In some embodiments, building security system computers are enterprise applications 170 accessible to activity determiner 155. In addition to RFID information, building security computers can access motion-detectors and other monitoring sensors, and these sensors can provide additional information to application determiner 155 (e.g., sensor 140, in this example, is a motion detector having a beam 142 monitoring resource 110).

The activities determined for a resource by activity determiner 155 can be altered for additional reasons once determined. For example, in some embodiments, determined activities may be relayed in a query to the resource for review. A query can be generated to present the activities a resource, and receive results from the resource indicating confirmation of the determined activities. For example, an application executing on mobile device 135 can be used to submit queries to, and receive results from, resource 110. In this example, the activity determined to have been performed between 6:55 AM and 7:45 AM is requested to be confirmed by resource 110 using an application executing on mobile device 135. In some embodiments, the starting and ending times are stored for the activity, and in some embodiments only the time amount spent on the activity is stored (e.g., 50 minutes from 6:55 AM to 7:45 AM).

In an example of altering determined activity characteristics by some embodiments, FIGS. 2-3, discussed below, are examples of user interfaces that can be used by some embodiments to submit queries to, and receive results from, resources, using mobile device 135 or other similar approaches, e.g., an application executing on a desktop computer system operated by resource 110. The results of these queries can be used by some embodiments to alter the activities determined (e.g., which activities are determined to have been performed by a resource, and/or the amount of time spent on each activity).

It is important to note the general sequence of events described herein for the determination of activities of resources. Automatic time tracking for a resource is performed by using data to determine an activity, and that activity is modified to increase the accuracy of the determined activity (e.g., rather than determining time spent on an activity solely based on scheduling application 175C, the determined activity is modified based on sensor data).

In some embodiments, time manually entered by a resource into a time tracking system can be checked for accuracy against activities determined according to approaches described herein. For example, if a resource reports time spent performing a particular activity (e.g., in a time recording data system), some embodiments can independently determine (e.g., using sensor data) the activities performed by the resource. In this example, before the reported activity data is used (e.g., to determine billing to clients for the activities), the reported activity data can be compared to the activities determined by some embodiments. In another example, the time entered into a time recording data system can be used to augment sensor and other data to determine activities for the resource. For example, when some embodiments are analyzing sensor data to determine activities performed by a resource, the reported time spent on activities by the resource can be used to improve the process.

FIG. 2 is an example of a user interface 240 used by some embodiments to present a query to a resource from a computer system having an activity determining component (e.g., server 150 having activity determiner 155 installed therein, according to some embodiments). In the example query shown in user interface 240, each of three activities 230A-C have been determined by activity determined 155 to have been performed by resource 110. In the example shown in FIG. 2, “Crunch” and “MCCDC” are activities that correspond to projects, and box 230A and 230B are respectively populated with the time determined (i.e., estimated) to have been performed (“4”, “2”) by the resource on these projects. In some embodiments, the association of these projects with the resource is determined by a retrieval of this information from an enterprise application server 170 (e.g., a project management system).

In this example, box 230C shows a zero value for time estimated as performed on the “Zoomph” project. In some embodiments, this zero value is included in a query from activity determiner 155 to enable confirmation of the zero-value using user interface 340. In some embodiments, zero time determined activities are left out of this type of query, while in other embodiments, some zero time determined activities are included for confirmation (e.g., box 230C), while others are omitted from the query, e.g., based on some criteria (a determined confidence value in the zero-time estimated, the importance of the project, etc.).

Upon receipt of this query (e.g., using mobile device 135 or other similar approach), resource 110 can confirm or change the estimated values 230A-C. In some embodiments, user interface 340 displays the query shown, but no values are entered into boxes 230A-C. Resource 110 can provide results to the query, with the results being used by some embodiments of activity determiner 155 as described below.

In some embodiments, the results in boxes 230A-C from the resource are transmitted from mobile device 135 to activity determiner 155, where the determined activities are modified based on these results. Examples of modifications of determined activity values are discussed below with the discussion of FIG. 5.

FIG. 3 is another example of a user interface for enabling responses to some queries generated by activity determiner 155. Similar to FIG. 2 discussed above, in this example, “Crunch”, “Zoomph”, and “MCCDC” are activities that correspond to projects available to be performed by the resource. In this example, user interface 340 includes controls 330A-C respectively, these controls enabling a resource to place these activities in a top to bottom order in response to prompt 360. In some embodiments, this order corresponds to a priority, assigned to the activity by the resource, for performing the activities listed.

In some embodiments, user interface 340 presents activities that could be performed by the resource in the future, and this priority for each activity can be used to help identify the activity when it is performed by the resource. For example, because the “Crunch” project is the highest priority activity (e.g., control 330A at the top of the list), in the future, received sensor information could be presumed to indicate the performance of that activity, unless contradictory data is received. One having skill in the relevant art(s), given the description herein, will appreciate other uses for these priority results by some embodiments.

### Detailed Architecture

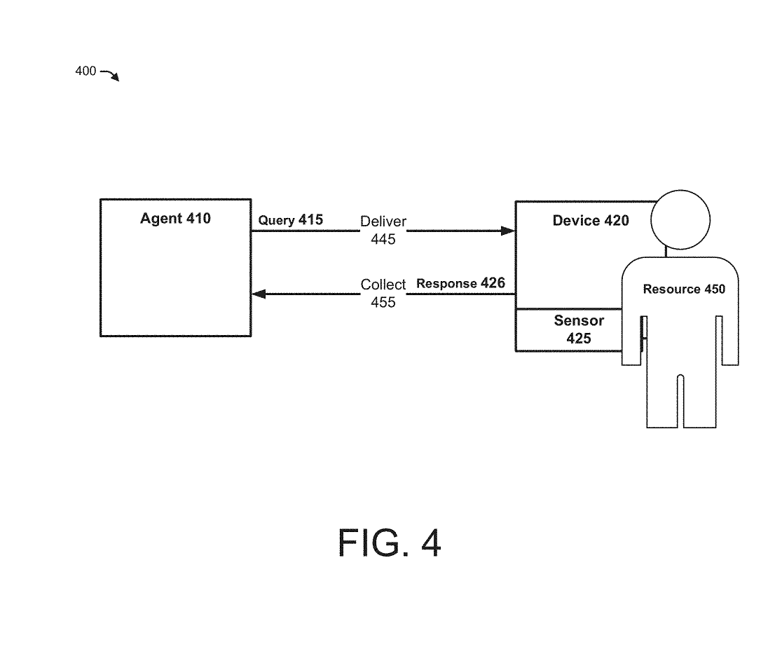

FIG. 4 illustrates a system 400 of interaction between agent 410 and device 420, used by some embodiments to determine activities of resources. The components depicted in FIG. 4 include agent 410, device 420, and resource 450. Connection 445, labeled as delivering query 415, and connection 455, labeled as collecting response 426, are depicted as connecting agent 410 to device 420. Device 420 includes sensor 425, device 420 being similar to mobile device 135, and sensor 425 being similar to sensor 145, described with FIG. 1 above.

As used by some descriptions herein, an agent (e.g., agent 410) is defined as an automated process that can create a query to request additional data, and analyze responses to queries from resources and other sources of data. Described with reference to the components of a system for determining activities of resources illustrated in FIG. 1, an agent is a part of activity determiner 155. Device 420 in some embodiments, can receive a query, interpret the query (e.g., determine what data is requested by the query), and can generate a response (e.g., information about activities) to provide as results to agent 410 in activity determiner 155.

FIG. 5 illustrates components of an example architecture of activity determining component used by some embodiments, e.g., activity determiner 155 in FIG. 1. The component includes two (2) modules, query component 510 and results component 520, these being respectively similar to query component 157 and results component 158 of FIG. 1.

In some embodiments, resource 110 is a person, and mobile device 135 is configured to use sensors to monitor their activities, i.e., collect information about, and identify their activities. Traditionally, organizations struggle to get their employees to submit timesheets and expense reports accurately and on time. Using passive monitoring of activities, some embodiments use a conditional logic process to predict which projects a resource is working on, query the resource if needed, then automatically fill out electronic timesheets based on the activities determined. In some embodiments, artificial intelligence approaches to determining natural language meanings are used to interpret responses from the resource and generate queries to be transmitted to the resource.

A response to a query is received from devices 595 and ingested 528 into results component 158. In some embodiments, results component 158 includes at least one of answers 526, images 527, or audio capture 528, where different types of responses from devices 595 (text, images, audio respectively) can processed by results determining engine 524 to yield the requested data.

Based on the processed results, some embodiments modify the characteristics of determined activities using results determining engine 524. In FIG. 5, an example use for which determined activities can be used is shown. In submission 522, results from results determining engine 524 are user to generate a record of determined activities, e.g., a time record (e.g., timesheet 560) and an expense record (e.g., expenses 570). Also from submission 522, determined activities can be stored directly in time management system 590 for the resource and the activities determined for resource.

In some embodiments, different types of data can be accessed and analyzed that can be used to deduce the morale of a resource, e.g., the confidence, enthusiasm, and discipline of a human resource or group of resources as applied to different activities. The broad variety of data ingested and analyzed by embodiments (e.g., emails, collaboration communications, and other interactions between resources and the enterprise) can be applied to assessing morale and, in turn, the determined morale can provide additional data to some embodiments for determining resource activities. In addition, determining and improving morale can improve the performance of resources with different tasks and projects.

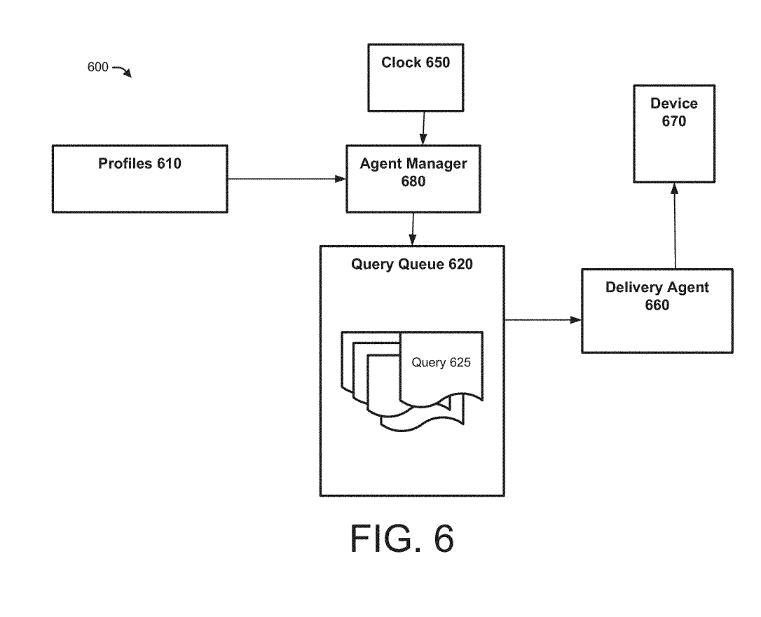

FIG. 6 illustrates a system 600 having query queue 620 and agent manager 680. Query queue 620 is a complex data structure that can be used to temporarily store query 625 before delivery to device 670, e.g., using delivery agent 660.

In some embodiments, agent manager 680 controls agents (e.g., agent 410 discussed with FIG. 4) to generate and deliver queries to a device (e.g., device 670). In some embodiments, queries can be generated and delivered at specific times, e.g., based on the known operation of a resource and times likely to trigger a useful response from the resource. To this end, in some embodiments, agent manager 680 coordinates the population of query queue 620 with clock 650. Further to this selection of times for the delivery of queries, in some embodiments, agent manager 680 retrieves resource profiles from profiles 610.

In an example implementation, profiles 610 contains classifications of available resources, these classifications each including four times selected to improve the delivery and response to queries. These delivery times may be selected by embodiments based on the type of resource, the schedule used by the resource, the types of activities performed by the resource, etc. In some embodiments, artificial intelligence can be used to automatically generate profiles, based on responses to queries from resource and other ingested information. In an example, the profiles 610 classifications are generated to determine the best times to query resources for activity information. In some examples, the selected times reflect the usage of a resource and the role of the resource within the organization. In some embodiments, the time selected to query a particular resource can affect the likelihood of response, or the accuracy of the results provided, e.g., human resources may be uncooperative if queries are presented for information at inconvenient times (early in the morning, during break time, etc.).

These example profile classifications and times are included below:

Profile: A—0715, 1115, 1515, 1915 (e.g., for resources with early morning and early evening availability).

Profile: B—0815, 1215, 1615, 2015

Profile: C—0915, 1315, 1715, 2115

Profile: D—1015, 1415, 1815, 2215 (e.g., for resources with late morning and late evening availability).

One having skill in the relevant art(s), given the description herein, will appreciate additional, different uses for which classification of resources can be directed.

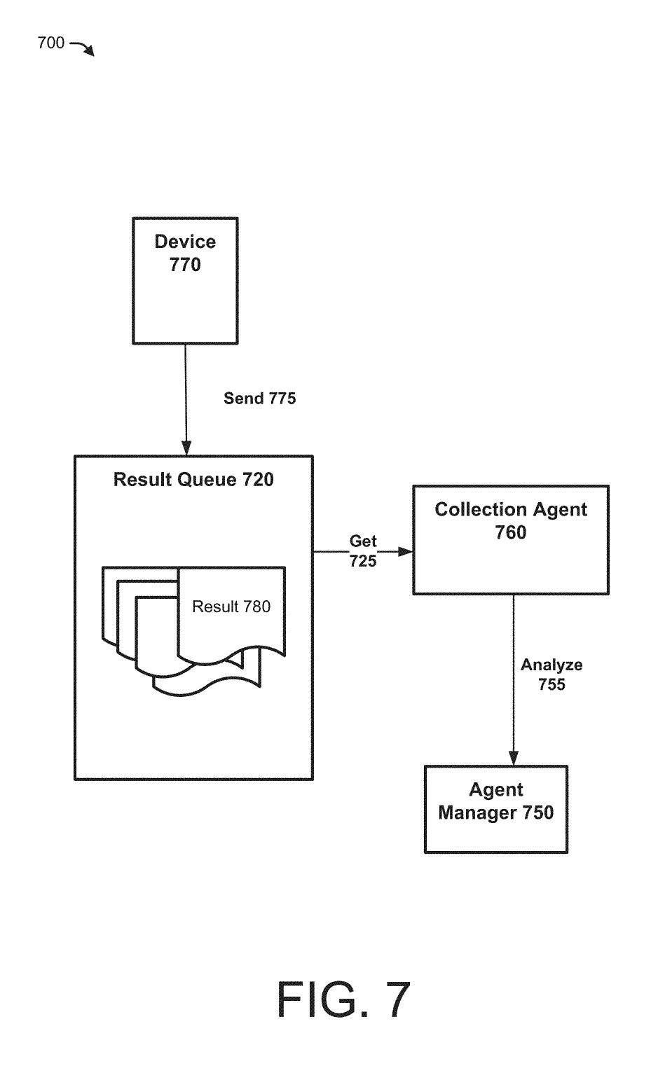

FIG. 7 illustrates system 700, with result queue 720 configured to receive results of queries from device 770, optionally store the result 780 temporarily, and allow collection agent 760 to get 725 the results from the results queue. In some embodiments, agent manager 750 receives results and analyzes the information about activities included therein.

In some embodiments, results (e.g., activity information in response to a query) are stored within an external database. This use external services for storage can, in some embodiments, improve the performance of other external services, e.g., services including language processing, speech processing, and image processing. In some embodiments, external services that utilize artificial intelligence can also be used improve the analysis of activity information an otherwise gain resource and organizational insights.

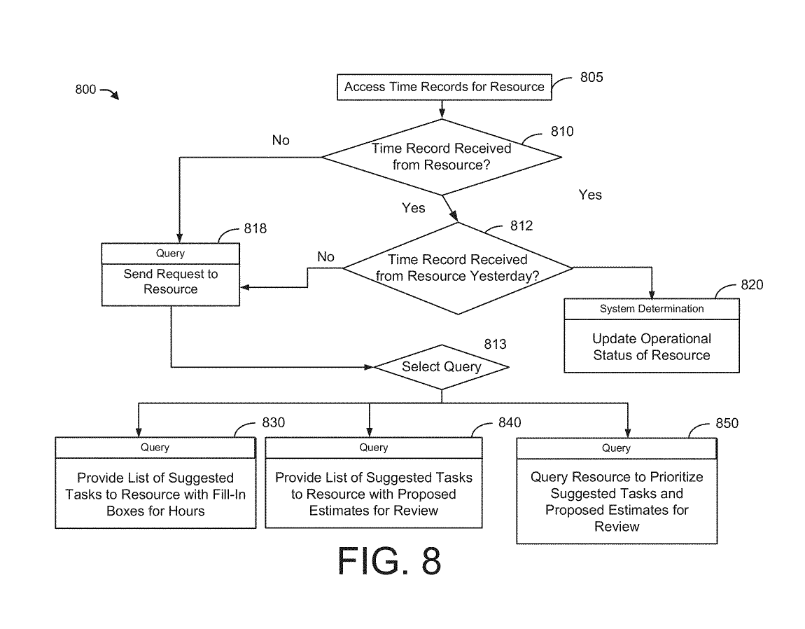

FIG. 8 is a flowchart 800 of different approaches to generating time records for resources using determined activities, according to some embodiments. Generally speaking, some embodiments described by flowchart 800 retrieve time records for a resource from a time management application (e.g., a networked application used by an enterprise to collect and process voluntary submissions of time records from resources), analyze the time records, and select a query for gathering additional information from the resource. Flowchart 800 is discussed in further detail below.

At 805, time records for a resource are accessed. In an embodiment, activity determiner 155 accesses an enterprise application server 170 that collect and process voluntary submissions of time records from resources, e.g., a timesheet application, for human resources.

At 810, some embodiments determine whether a time record has been received in the time record application for the resource. As noted in the background above, a current problem of time record applications is their inconsistent use by some resources. At 810, in some embodiments, compliance with guidelines for time entry for the time record application are tested for the resource. When no records (or incomplete records) are detected, some embodiments use 818 in flowchart 800, and when records (some records, or complete records) are detected by some embodiments, 812 in flowchart 800 is followed.

At 812, when records are found for a resource in a given time period (e.g., today), time records are analyzed for a previous time period (e.g., yesterday). When no records (or incomplete records) are detected for the previous time period, 818 in flowchart 800 is used. When time records are detected for the previous time period, operation of flowchart 800 goes to 820.

At 818, a query is generated that requests that missing time record information be provided by the resource. To enable this, some embodiments use 813 to select a type of query (e.g., 830, 840, 850) to use to gather additional information from the resource. Query 830 is similar to the user interface 240 discussed with FIG. 2 (a list of activities is provided with boxes 230A-C for hours). Query 840 is similar to query 830, but estimated hours are filled in to boxes 230A-C, for change or confirmation by a resource. Query 850 is similar to queries 830 and 840, but with the addition of controls to enable the prioritization of suggested tasks, e.g., discussed with the description of FIG. 3 above. One having skill in the relevant art(s), given the description herein, will appreciate that additional types of queries, with additional user interfaces, can be used to gather, and promote the completeness of, time record information for the resource.

At 820, when time record information is complete for the resource over a current and previous time period (e.g., a resource has completely submitted time sheets for yesterday and today), in some embodiments, this successful receipt of information from a resource can trigger an update of the operational status of the resource. For a human resource, this operational status can be a happiness index, a resource workload index, a resource satisfaction index, a performance index, etc. As noted above, these scores can be used to determine resource morale for use with other system processes. In addition, in some embodiments, these resource operational status indexes can be combined into an aggregate score (e.g., termed by some embodiments a “crunch score”). All of these operational status indicators can also improve the assessment of resources during performance appraisals and, for human resources, provide data on individual and group morale in an organization.

Some embodiments improve the operation of timesheet system by features including making data entry easier for resources by reducing the number of projects from which a resource must pick to enter time, automatically estimating the amount of time spent on an activity, and pushing a query to the resource using a mobile device, i.e., not making a resource log in and use a time management application.

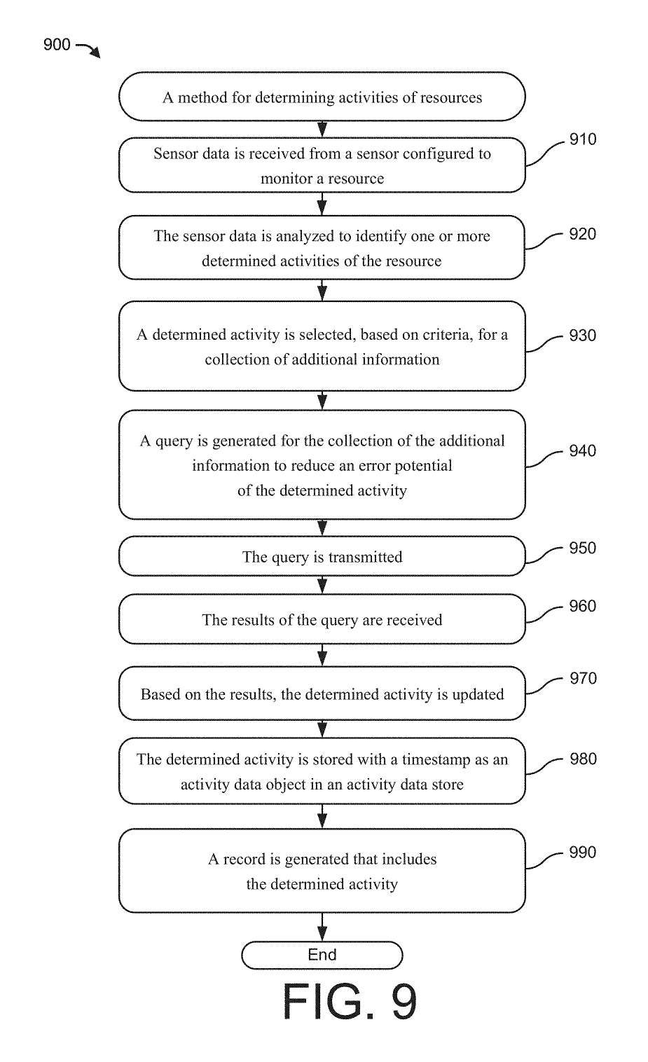

FIG. 9 is a flowchart of a method and a system of determining an allocation of resources, according to some embodiments. At 910, sensor data is received from a sensor configured to monitor a resource. In some embodiments, sensor data (e.g., movement data from an accelerometer, location data from a GPS receiver, RFID sensor information) is received (e.g., by activity determiner 155 via network 180) from a sensor (e.g., sensors 140 and 145 in mobile device 135, vehicle systems 147 sensors in a vehicle, sensor implants in an organism, etc.) configured to monitor a resource (e.g., resource 110).

At 920, the sensor data is analyzed to identify one or more determined activities of the resource. In some embodiments, the sensor data is analyzed (e.g., movement data is analyzed to determine that resource 110 is moving, GPS data is analyzed to determine the location of resource 110) to identify one or more determined activities (e.g., analyzed movement characteristic may indicate an activity performed by resource, location may indicate activities performed by resource, vehicle systems 147 data may indicate travel being performed by resource) of the resource. As discussed above, some embodiments monitor some or all of the external and sensor data sources discussed above, at intervals or in real-time, to constantly and dynamically determine activities for resources, e.g., based on factors including, for example, tasks upon which a resource is permitted to work, a location for the resource, the time of day, past behavior, and current movement detected.

At 930, a determined activity is selected, based on criteria, for a collection of additional information. In some embodiments, a determined activity is selected (e.g., the GPS location data as indicating activities performed by a resource at a location), based on criteria (the location data limiting activities being performed), for a collection of additional information (e.g., generation of a query that requests information on activities being performed at the location).

At 940, a query is generated for the collection of the additional information to reduce an error potential of the determined activity. In some embodiments, a query is generated for the collection of the additional information (e.g., to limit the activities performed at the GPS location) to reduce an error potential of the determined activity (e.g., at the location, three different activities can be performed, query asks to limit the three to only the ones actually being performed).

At 950, the query is transmitted, and at 960 the results of the query are received. In some embodiments, the query is transmitted (e.g., generated by query component 157 in activity determiner 155 and transmitted via network 180 to mobile device 135). A resource (e.g., resource 110) views an application executing a mobile device (e.g., mobile device 135 displaying user interface 240) requesting the generated query information (e.g., projects with fill in boxes 230A-C) from a resource (e.g., resource 110). Results (e.g., the entries from boxes 230A-C) are received (e.g., with ingest 528 by results component 158 in activity determiner 155).

At 970, based on the results, the determined activity is updated. In some embodiments, based on the results (e.g., received in results component 158 by answers 526 component), the determined activity is updated (e.g., results determining engine 524 updates the determined activities to match the entries in boxes 330A-C of user interface 340, from resource 110).

At 980, the determined activity is stored with a timestamp as an activity data object in an activity data store. In some embodiments, the determined activity (e.g., as shown in FIG. 3, 4 hours spent on the “Crunch” activity from user interface 340) is stored with a timestamp as an activity data object in an activity data store (e.g., as activity data object 161 stored in activity data store 160).

At 990, a record is generated that comprises the determined activity. In some embodiments, a record is generated (e.g., submission 522 component retrieves activity data object 161 from activity data store 160, and modifies activity data object 161 if needed, based on results determining engine 524) that comprises the determined activity (e.g., timesheet 560 is generated from the data).

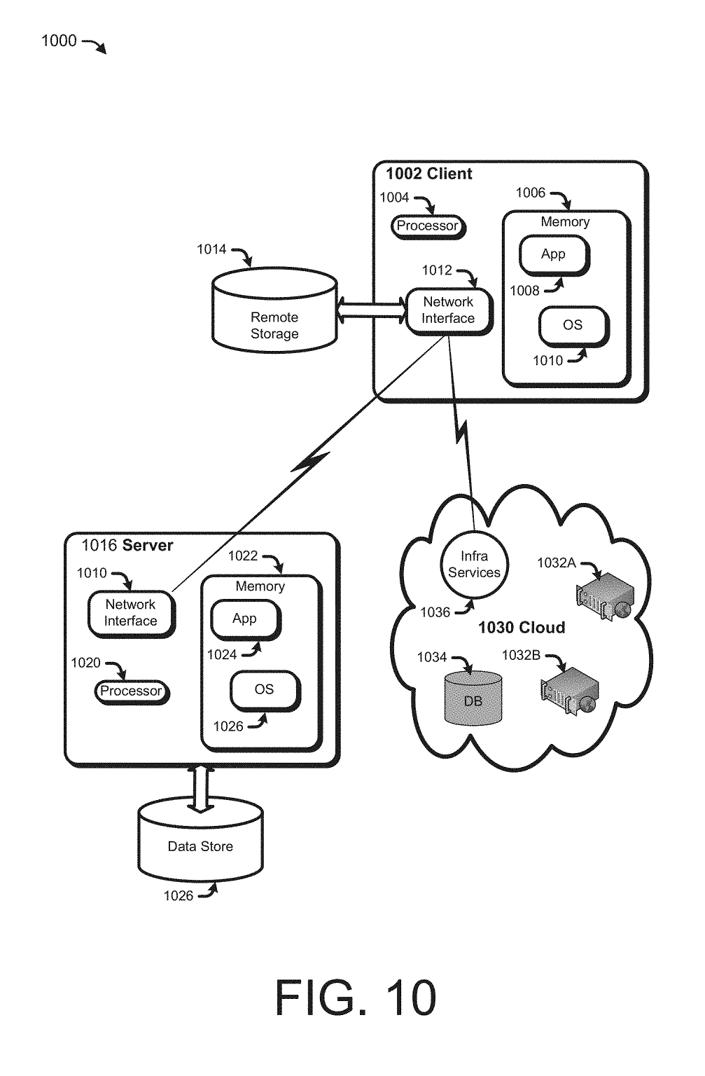

FIG. 10 illustrates an exemplary hardware and software configuration used by some embodiments. Client device 1002 is any computing device. Exemplary computing devices include without limitation personal computers, tablet computers, smart phones, and smart televisions and/or media players. In some embodiments, resources can use client device 1002 to perform tasks, and activities can be determined for a resource based on information collected from the activity of client device 1002. In addition, some embodiments use client device 1002 to present queries to resources in ways similar to those discussed above with mobile device 135 (e.g., using user interfaces 340 and 340 to present query information on a display of client device 1002).

Client device 1002 may have a processor 1004 and a memory 1006. Memory 1006 of client device 1002 can be any computer-readable media which may store several software components including an application 1008 and/or an operating system 1010. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment, client device 1002 may have a network interface 1012. The network interface 1012 may be one or more network interfaces including Ethernet, Wi-Fi, or any number of other physical and data link standard interfaces.

Client device 1002 may communicate to server 1016 in a client-server/multi-tier architecture. In some embodiments, server 1016 can be any computing device that can connect to network 180. As noted above, network 180 may be, without limitation, a local area network (“LAN”), a virtual private network (“VPN”), a cellular network, or the Internet. Client network interface 1012 may ultimately connect to remote networked storage 1014, or to server 1016 via server network interface 1018. Server network interface 1018 may be one or more network interfaces as described with respect to client network interface 1012. In some embodiments, server 150, enterprise application server 170, and external data server 190 have features similar to server 1016.

Server 1016 also has a processor 1020 and memory 1022. As per the preceding discussion regarding client device 1002, memory 1022 is any computer-readable media including both computer storage media and communication media.

In particular, memory 1022 stores software which may include an application 1024 and/or an operating system 1026. Memory 1022 may also store applications 1024 that may include without limitation, an application server and a database management system. In this way, client device 1002 may be configured with an application server and data management system to support a multi-tier configuration.

Server 1016 may include a data store 1028 accessed by the data management system. The data store 1028 may be configured as a relational database, an object-oriented database, a NoSQL database, and/or a columnar database, or any configuration to support scalable persistence.

Server 1016 need not be on site or operated by the client enterprise. The server 1016 may be hosted in the Internet on a cloud installation 1030. The cloud installation 1030 may represent a plurality of disaggregated servers which provide virtual web application server 1032 functionality and virtual database 1034 functionality. Cloud services 1030, 1032, and 1034 may be made accessible via cloud infrastructure 1036. Cloud infrastructure 1036 not only provides access to cloud services 1032 and 1034 but also billing services. Cloud infrastructure 1036 may provide additional service abstractions such as Platform as a Service (“PAAS”), Infrastructure as a Service (“IAAS”), and Software as a Service (“SAAS”).

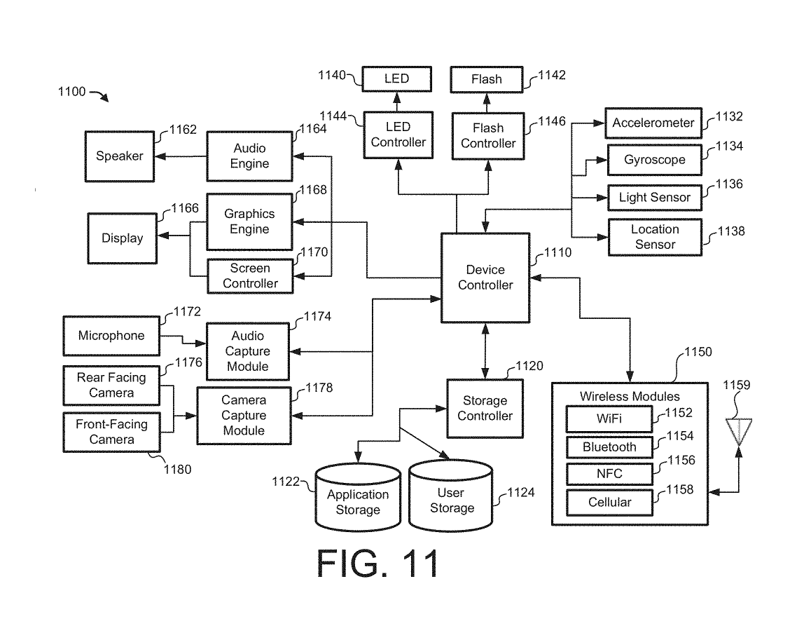

FIG. 11 illustrates an exemplary hardware and software configuration used by a mobile device, e.g., mobile device 135 shown in FIG. 1. Mobile device 135 can connect to network 180 using one or more antennas 1159, and wireless modules 1150 (e.g., Wi-Fi 1152, Bluetooth 1154, NFC 1156 and/or cellular 1158). Once connected to site network 180, mobile device 135 can use input and output hardware components and sensors to enable different embodiments described herein.

In some embodiments, input sensors (e.g., sensor 145) used by mobile device 135 can include, accelerometer 1132, gyroscope 1134, and light sensor 1136. Location engine 1138 can use geolocation hardware components (e.g., wireless signal receivers, iBeacon, NFC, GPS, and/or other similar components). In some embodiments, mobile device 135 can also use sensors to locate nearby mobile devices (e.g., Bluetooth 1154, NFC 1156, and or other similar sensing hardware). Other input components used by some embodiments include microphone 1172, camera 1176, and front-facing camera 1180, respectively controlled and/or providing capture by audio capture module 1174 and camera capture module 1178. One having skill in the relevant art(s), given the description herein, will appreciate that other input and or sensor components can be used by embodiments of mobile device 135.

Output components used by some embodiments include speaker 1162, display 1166, LED 1140, and flash 1142, respectively controlled and/or relayed output information by, audio engine 1164, graphics engine 1168, screen controller 1170, LED controller 1164, and flash controller 1146. Other output components used by mobile device 135 include NFC 1156 and Bluetooth 1154, which, beyond wireless communication capabilities can also be used to detect other devices nearby, i.e., devices used by other resources.

Embodiments and all of the functional operations described in this specification (e.g., some or all of method 900, operations of system 100, and components described in FIG. 5) may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. Examples of computer-useable media include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

1. A system for determining activities of resources, comprising:
at least one processor;
a memory communicatively coupled to the at least one processor;
a transceiver configured to receive sensor data from a sensor configured to monitor a resource;
an activity data store, communicatively coupled to the at least one processor, configured to store one or more activity data objects, each activity data object comprising timestamp information and information corresponding to an activity of a resource; and
an activity determining component resident in the memory, configured to:
receive the sensor data,
analyze the sensor data to determine one or more activities of the resource,
select, based on criteria, a determined activity for a collection of additional information,
generate, based the resource and the determined activity, a query for the collection of the additional information, the query being generated to reduce an error potential of the determined activity,
wherein the transceiver is further configured to:
transmit the query;
receive results in response to the query, and
wherein the activity determining component is further configured to:
update the determined activity based on the results,
store the updated determined activity and a timestamp as an activity data object in the allocation data store, and
generate, based on the allocation data object, a record comprising the determined activity.

2. The system of claim 1,
wherein the query is transmitted to the resource, and
wherein the results are received from the resource.

3. The system of claim 1, wherein the activity determining component is further configured to:
receive application information from an application based on the results and the determined activity,
update the activity data object to include the application information, and
update the determined activity based on the application information.

4. The system of claim 1, wherein the sensor is one of:
a fitness tracker
a sensor implanted in an organism,
a sensor in an unmanned aerial vehicle (UAV),
a sensor in an earth observing satellite,
a smart watch,
a motion sensor,
a sensor configured to detect use of furniture,
a radio frequency identifier (RFID), and
a Bluetooth low energy (BLE) beacon.

5. The system of claim 1, wherein the query is a natural language query.

6. The system of claim 1, wherein the record is a timesheet, and the determine activity is a task performed by the resource.

7. The system of claim 6, wherein the at least one processor is further configured to generate an expense report based on at least one of the task, the resource, application data from an application, or the sensor data.

8. The system of claim 3, wherein the application is one of:
a word processor application,
an email application,
an asynchronous communication application,
an integrated development environment for programming,
a calendar application,
a podcasting application,
a task list application,
an intranet portal,
a source control application,
a collaboration application,
a web browser, and
a navigation application.

9. The system of claim 1,
wherein the criteria are billing codes assigned to the one or more determined activities, and
wherein the determined activity is selected for the collection of activity information based on a billing code associated with the determined activity.

10. The system of claim 1,
wherein the at least one processor is further configured to classify the one or more determined activities, and
wherein the criteria comprise classifications of the one or more determined activities.

11. The system of claim 1, wherein the at least one processor is further configured to reduce the error potential associated with the determined activity based on the results.

12. The system of claim 1, wherein the transmitting of the query comprises transmitting the query to the resource using one or more of Wi-Fi, Bluetooth, near field communication (NFC), or cellular communication.

13. The system of claim 1, wherein the receiving of the results comprises receiving the activity information using one or more of Wi-Fi, Bluetooth, near field communication (NFC), or cellular communication.

14. A method of determining activities of resources, the method comprising:
receiving sensor data from a sensor configured to monitor a resource;
analyzing the sensor data to identify one or more determined activities of the resource;
selecting, based on criteria, a determined activity of the one or more determined activities, for a collection of additional information;
generating, based the resource and the determined activity, a query for the collection of the additional information, the query being generated to reduce an error potential of the determined activity;
transmitting the query;
receiving results in response to the query;
updating the determined activity based on the results;
storing the determined activity and a timestamp as an activity data object in an activity data store; and
generating, based on the activity data object, a record comprising the determined activity.

15. The method of claim 14,
wherein the query is transmitted to the resource, and
wherein the results are received from the resource.

16. The method of claim 14, further comprising:
receiving application information from an application based on the results and the determined activity;
updating the activity data object to include the application information, and
updating the determined activity based on the application information.

17. The method of claim 14, wherein the sensor is one of:
a fitness tracker,
a smart watch,
a motion sensor,
a sensor implanted in an organism,
a sensor in an unmanned aerial vehicle (UAV),
a sensor in an earth observing satellite,
a sensor configured to detect use of furniture,
a radio frequency identifier (RFID), and
a Bluetooth low energy (BLE) beacon.

18. The method of claim 14, wherein the query is a natural language query.

19. The method of claim 14, wherein the record is a timesheet, and the determined activity is performance of a task by the resource.

20. The method of claim 19, further comprising, generating an expense report based on at least one of the task, the resource, application data from an application, or the sensor data.

21. The method of claim 16, wherein the application is one of:
a word processor application,
an email application,
a synchronous communication application,
an integrated development environment for programming,
a calendar application,
a podcasting application,
a task list application,
an intranet portal,
a source control application,
a collaboration application,
a web browser, and
a navigation application.

22. The method of claim 14,
wherein the criteria are billing codes assigned to the one or more determined activities, and
wherein the determined activity is selected for the collection of additional information based on a billing code associated with the determined activity.

23. The method of claim 14, further comprising:
classifying the one or more determined activities,
wherein the criteria comprise classifications of the one or more determined activities.

24. The method of claim 14, further comprising, reducing the error potential of the determined activity based on the results.

25. The method of claim 14, wherein the transmitting of the query comprises transmitting the query to the resource using a short message service protocol (SMS) message.

26. The method of claim 14, wherein the receiving of the results comprises receiving the results from the resource using a short message service protocol (SMS) message.
